(19) United States
(12) Patent Application Publication
(10) Pub. No.: US 2004/0003506 A1
(43) Pub. Date: Jan. 8, 2004

(54) Speed jig

(76) Inventor: Kelly Bart Cuell, Orem, UT (US)

Correspondence Address: KELLY CUELL, 975 S MAIN ST., OREM, UT, 84058, US

(21) Appl. No.: 10/345,703

(22) Filed: Jan. 16, 2003

Related U.S. Application Data
(60) Provisional application No. 60/348,991, filed on Jan. 16, 2002.

(51) Int. Cl. B43L 13/00

(52) U.S. Cl. 33/478

(57) ABSTRACT

When I thought of the Speed jig it was to help speed up the construction process. The Speed Jig does this by eliminating the need to measure and mark the material being cut when making consecutive cuts using a handheld circular saw. The Speed Jig is simply a rule of measurement that compensates its measurements for the distance from the table of the saw, to the blade of the saw. What you set the measurement on the jig at is what it is going to cut once the table of a circular saw is passed along the fence of the jig.

### CROSS REFERENCE TO RELATED APPLICATIONS

None

### STATEMENT REGUARDING FEDERALLY SPONSORED RESEARCH AND DEVELOPMENT

None

### REFERENCE TO SEQUENCE LISTING

None

### BACKGROUND OF INVENTION

The field of endeavor to which the speed jig pertains is the construction industry. More specifically, the framing industry or any person that would use a handheld circular saw to cut lumber. In these situations in order to make consecutive cuts one must first; use a tape measure or other unit of measure to measure the piece to be cut. Second; mark the distance with a pencil or other marking device and third in order to ensure that the cut the user will make with the handheld circular saw is square, the mark must be squared across the piece of material using a squaring device. Taking into account these time consuming tasks The Speed Jig was invented to delete the process, allowing the user to make unlimited consecutive identical cuts by simply moving the jig down the material being cut.

### BIEF SUMMARY OF THE INVENTION

The general idea of the invention is that it is a jig for a hand held circular saw. By setting the jig to the desired measurement and placing it on a piece material, one can cut the same measurement over and over simply by setting the jig on the material and running the table of the saw along the fence of the jig. The jig works together with the saw by taking onto account the distance that exists from the table of the saw to the blade. By including this distance in the measurement of the jig it is able to eliminate the process of having to measure, mark the lumber, and square the mark across the lumber in order to get a precise cut.

The advantage of the jig is that it saves time by eliminating the process of having to measure, mark and square the mark across the material being cut. The jig also saves the wear and tear on the other tools. Tape measures and marking instruments are not used as often or as rigorously therefore they last longer. Physically it takes less effort to use the jig giving the user the ability to do the task more quickly, efficiently and precisely. The end result is the money spent on the purchase of the jig is returned to the user ten fold.

### BRIEF DESCRIPTION OF THE SEVERAL VIEWS OF THE DRAWINGS

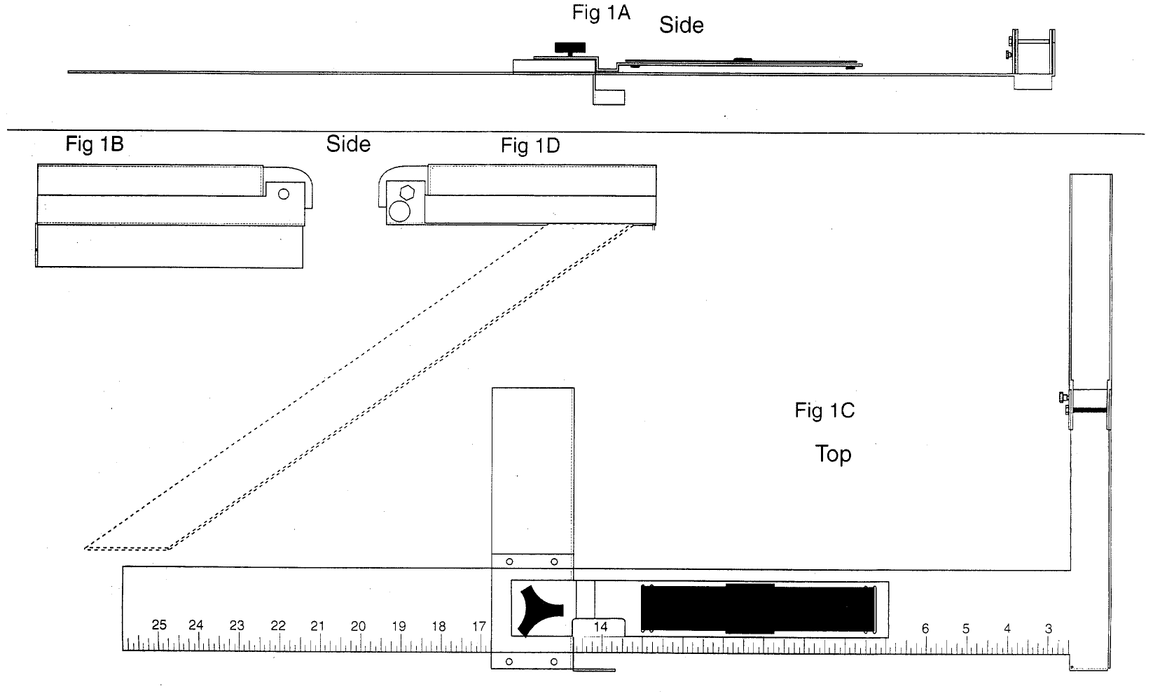

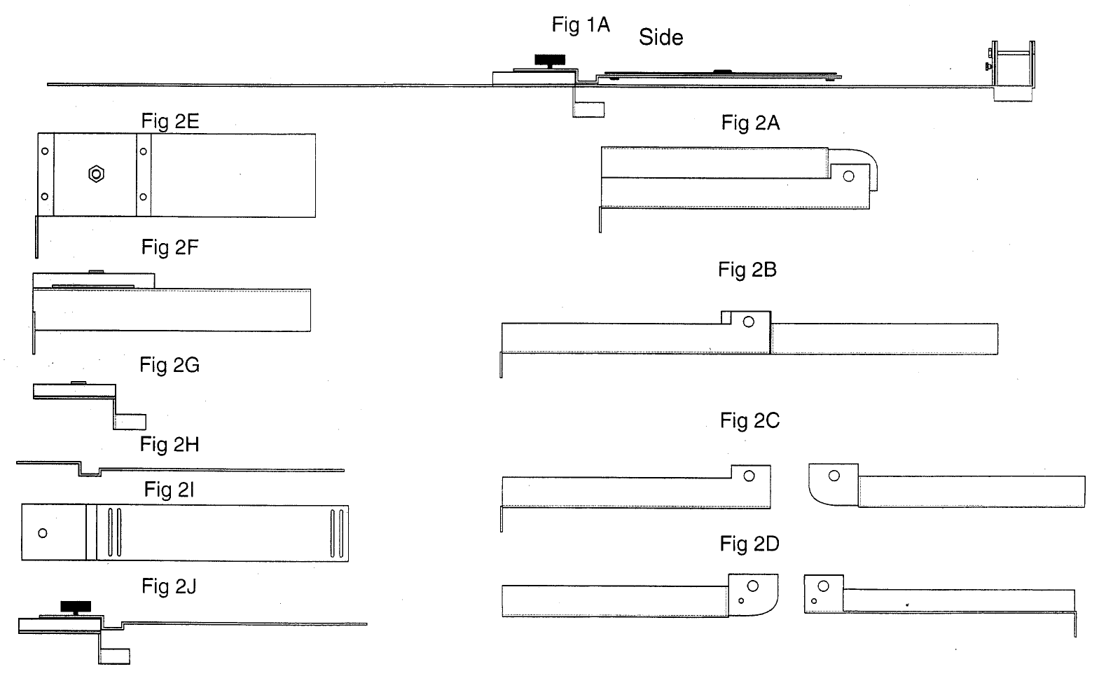

Page 1 of the drawings shows a side view (FIG. 1A) of the jig as if you were looking at it from the side that you would if you were going to put your left hand through the hand strap. In FIG. 1A you can see the tabs that hold the jig on the material. FIG. 1B shows the side view of the fold out arm that allows the jig to extend from short to long. The lower part of the FIG. 1B is showing the stop of the slide as if the jig were completely assembled. FIG. 1C. is a top view of the jig with the fold out arm extended into position. FIG. 1D is the opposite side of FIG. 1B. And shows an abstract view of the rule without any numbers stamped on it.

Page 2 shows FIG. 1A again at the top of the page in order to show how the following figures are broken down. FIG. 2A. is a side view of the fold out arm in the closed position and without the measuring slide show. FIG. 2B. is a view of the fold out arm in the fold out position. FIG. 2C. is to show how the insert piece of the fold out arm looks. FIG. 2D shows the inside view of the fold out arm with the two pieces apart and the view of the thumb screw. FIG. 2E. is a top view of the slide. FIG. 2F. is the side view of the slide. FIG. 2G. is the side view of the slide if rotated 90 degrees to the left of FIG. 2F. FIG. 2H. is a top view of the bracket for the hand strap. Shown without the elastic hand strap in place. FIG. 21. Is a side view of the bracket for the hand strap. FIG. 2J. is a side view of the slide completely assembled with the three-pronged bolt in place.

### DETAILED DESCRIPTION

The Speed jig is made from aluminum. Once the shape has been cut out the measurements are stamped. Holes that need to be threaded are, then all the 90 degree bends are made. The fold out arm is attached to the main body of the jig by placing the arm extension in the “U” shaped part of the jig. Once the holes are aligned a bold is fastened to secure the two pieces together. See FIGS. 1C, 2C and 2B.

The slide of the jig is manufactured in three pieces. The hand strap piece is stamped so that the four slots, a hole and a u shaped bend at the end. The slots are for the elastic strap to pass through, the hole is for the three pronged bolt to pass through and hold it securely to the slide and the bend allows the hand strap piece to lock securely in a parallel direction with the jig when the three pronged bolt is snug tight. The second piece is stamped out to the exact shape and the 90 degree bends are made. The top of the slide is also made of aluminum and has a slot milled out of it to let the rule of the jig slide through. It has four holes that are drilled and tapped and is fastened to the 90-degree bend piece with four bolts.

The speed jig is used by first placing ones left hand through the elastic hand strap. Second setting the slide to the desired measurement by loosening the three pronged bolt and moving the slide up or down the rule of the jig until the desired measurement is met and then tightening the three pronged bolt to secure the slide in place. Third once the slide is set the jig is placed on the material by holding the end of the material snug against the back of the slide of the jig and the side of the lumber snug to the two tabs which would be directly in front of the user if the jig was on the left hand with the numbers of the jig closest to him and may be describe as being vertical and on the bottom of the jig. (See FIG. 3A.) Once the jig is held securely on the desired piece of material to be cut the user simply takes the saw and runs the table of the saw down the fence of the jig. The process is repeated by simply moving the jig to a new piece of material.

As to my knowledge there are no other patented circular saw jigs that would interfere with the patent of the Speed Jig.

As of now the best mode of manufacturing has been to have the Speed Jig hard tooled and built out of aluminum. This allows the jig to be Very light weight and strong.

1. What I claim as my invention is the concept that the use of a predetermined set tool of measurement or jig, when placed on the desired material to be cut, can have the table of hand held circular saw pass securely along the fence of the jig to cut precisely and consecutively. This is accomplished by compensating its measurements for the distance from the table of the saw to the blade. The table of the saw is also described as part of the saw that is flat and allows the saw to ride on top of the material being cut.
The Speed Jig” is a construction-measuring tool that allows the user to make miscellaneous and consecutive saw cuts without having to measure or mark the material being cut. The Speed Jig is designed to be used together with any hand held circular saw table to run along the guard of the Speed Jig to make consecutive precise measurements without the need of having to remeasure and mark the piece of material being cut.
